(19) United States
(12) Patent Application Publication
(10) Pub. No.: US 2018/0125013 A1
(43) Pub. Date: May 10, 2018

(54) MODULAR POT FOR A PLANT

(71) Applicant: Plantlogic LLC, Smyrna, GA (US)

(72) Inventor: Israel Holby, Sharpsburg, GA (US)

(21) Appl. No.: 15/344,623

(22) Filed: Nov. 7, 2016

(51) Int. Cl. A01G 9/02

(52) U.S. Cl. CPC A01G 9/02

(57) ABSTRACT

A container for a plant may include a base having an axis, and a sidewall configured to be rotationally attached to the base about the axis to form the container. The sidewall may be configured to surround a portion of the base and extend axially upward from the base.

### BACKGROUND OF THE INVENTION

### Field of the Disclosure

The present invention relates in general to pots and, in particular, to a system, method and apparatus for a modular pot for plants.

### Description of the Related Art

Berry plants, such as blueberry plants, are well suited for growth in a container due to their shallow root system that allows swift adaptation to reduced space. Blueberry roots are fibrous and have a small extension, and since they do not have hairs, the younger roots are the ones responsible for nutrients intake.

Another reason for growing blueberries in containers is that they require a specialized soil with a low and acid pH ranging between 4.5 and 4.8. With in-ground plantings, maintaining this low pH may require a concerted, ongoing effort, whereas by using a container or pot it is possible to create the ideal soil pH at planting time.

One method of growing in containers uses a pot described in USD426490, which provides a square pot, not showing any particular benefit for blueberries since its flat base is in direct contact with the ground. USD415065 discloses a pot of square structure with an upper peripheral border and vertical parallel bars equidistantly distributed over its outer sidewalls. This pot does not showcase a drainage system effective enough for blueberry growing. USD466829 discloses a pot of irregular square body with an independent element capable of being assembled in the base by way of a clamping system. In spite of exhibiting square structures, these pots do not have a base adequately engineered to allow proper packing and transportation. Furthermore, these pots are not favorable for high density blueberry production since they do not display space enough between the base and the ground thus preventing an efficient drainage of liquid waste produced as a consequence of plant growing. Thus, improvements in containers for plants continue to be of interest.

### SUMMARY

Embodiments of a container for a plant may include a base having an axis, and a sidewall configured to be rotationally attached to the base about the axis to form the container. The sidewall may be configured to surround a portion of the base and extend axially upward from the base.

Another embodiment of a container for a plant may include a base and a sidewall coupled to the base. The sidewall may have an inner layer and an outer layer. The outer layer may be lighter in color than the inner layer, and configured to reflect light away from the container. The inner layer may be darker in color than the outer layer, and configured to protect roots of the plant in the container from light exposure.

A third embodiment of a container for a plant may include a base and a sidewall configured to be coupled to the base. A fixture may be included to couple the sidewall to the base.

An embodiment of a method of forming a container for a plant may include forming a hot extruded pipe shape that is continuous and symmetrical about an axis with a pipe forming machine. The method may include blow molding the hot extruded shape into a different shape that is continuous. Next, the method may include cutting the different shape into substantially identical axial segments, each of which forms a sidewall for the container for the plant.

Another method of forming a container for a plant may include providing a base with an axis and a sidewall. The method may include axially placing the sidewall onto the base; and then rotating the base and the sidewall relative to each other about the axis to form the container.

Yet another embodiment of a container for a plant may include a base and two sidewalls. The first sidewall may have a first shape and be configured to be interchangeably mountable to the base. The second sidewall may have a second shape that is different from the first shape. The second sidewall may be configured to be interchangeably mountable to the base when the first sidewall is not mounted to the base.

Still another embodiment of a container for a plant may include a base and a sidewall attached to the base. When the container is not substantially filled with a plant substrate, the sidewall has a nominal sidewall shape. When the container is substantially filled with the plant substrate, the sidewall is forced by the plant substrate to shift to a second sidewall shape that differs from the nominal sidewall shape.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is a top isometric view of an embodiment of an assembly of a container for a plant.

FIG. 2 is an exploded, top isometric view of the embodiment of the container of FIG. 1 prior to assembly.

FIG. 3 is a top isometric view of another embodiment of a container for a plant.

FIG. 4 is a top view of an embodiment of a sidewall of the container of FIGS. 1 and 2.

FIG. 5 is a sectional view of a portion of the embodiment of the sidewall of FIG. 4, taken along the line 5-5 of FIG. 4.

FIG. 6 is an enlarged view of a lower end of the sidewall of FIG. 5, taken at the circle FIG. 6 in FIG. 5.

FIG. 7 is an enlarged side view of the lower end of the sidewall of FIGS. 1 and 2, illustrating one embodiment of a tab thereof.

FIG. 8 is an enlarged side view of the lower end of the sidewall of FIGS. 1 and 2, illustrating a second embodiment of a tab thereof.

FIG. 9 is an enlarged side view of the lower end of the sidewall of FIGS. 1 and 2, illustrating a third embodiment of a tab thereof.

FIG. 10 is a top view of a portion of an embodiment of a base of the container of FIGS. 1 and 2.

FIG. 11 is a sectional side view of the portion of the base of FIG. 10, taken along the line 11-11 of FIG. 10.

FIG. 12 is a top view of a second portion of an embodiment of the base of the container of FIGS. 1 and 2.

FIG. 13 is a top view of a third portion of an embodiment of the base of the container of FIGS. 1 and 2.

FIGS. 14A and 14B are schematic, top isometric views of a shape-shifting container for a plant, before and after plant substrate is added to the container.

FIG. 15 is an exploded, top isometric view of another embodiment of a container.

FIG. 16 is a top isometric view of an embodiment of a fixture for assembling containers.

FIG. 17 is a partial, side isometric view of an embodiment of a container the intentionally deforms when loaded with substrate.

The use of the same reference symbols in different drawings indicates similar or identical items.

### DETAILED DESCRIPTION

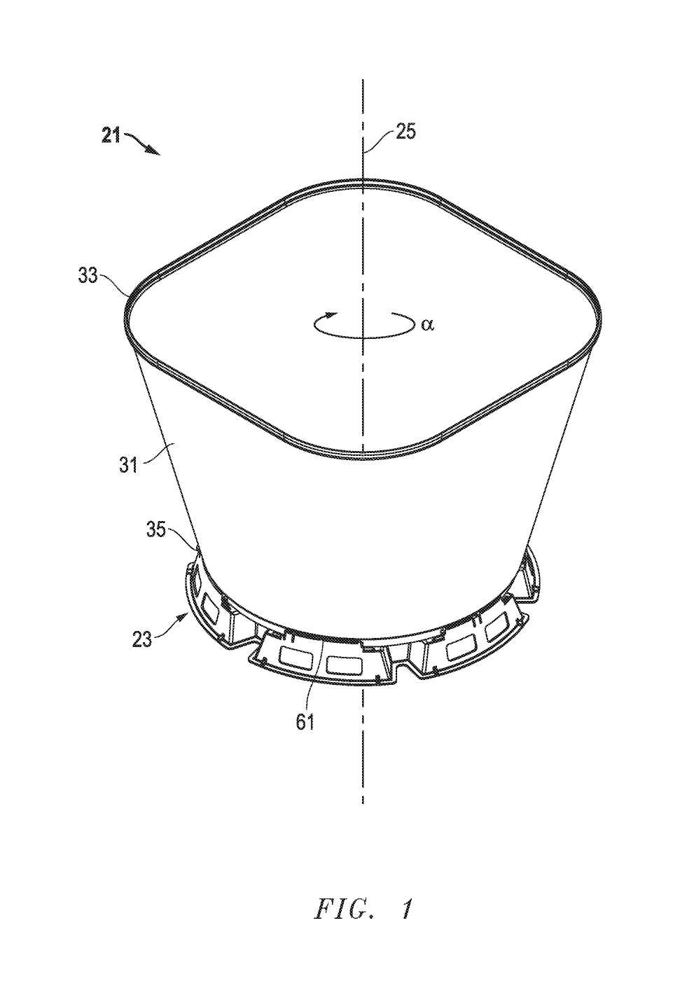

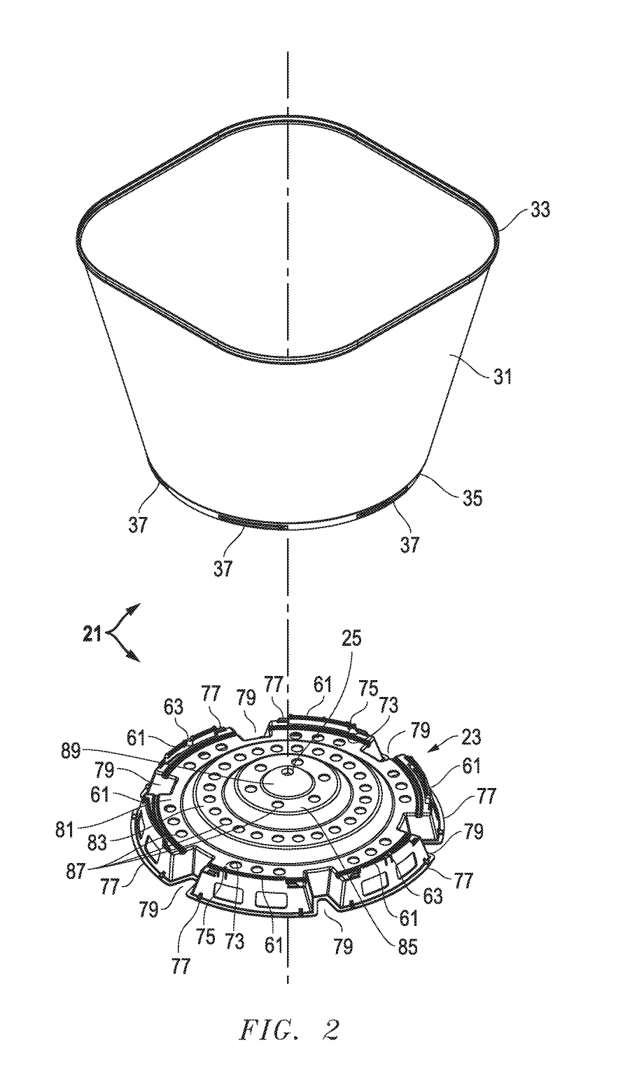

Embodiments of a system, method and apparatus for a pot or container for a plant are disclosed. For example, a container 21 (FIGS. 1 and 2) may comprise a tray or base 23 having an axis 25. A sidewall 31 may be configured to be attached to the base 23 about the axis 25 to form the container 21. The sidewall 31 may be configured to surround a portion of the base 23 and extend axially upward from the base 23. The base 23 may comprise a same material or a different material than the sidewall 31. In one version, the base 23 may have a wall thickness that is greater than that of the sidewall 31. In some versions, the sidewall 31 may include a wall thickness in a range of about 0.6 mm to about 1.5 mm. The wall thickness may vary along the axial length of the sidewall 31. For example, the wall thickness can be greatest at the small diameter end, and thinnest at the large diameter end. Embodiments may include a small diameter end in a range of about 250 mm to about 350 mm, and a large diameter end in a range of about 350 mm to about 450 mm.

The sidewall 31 may be attached to the base in a number of ways, such as axially, rotationally or a combination thereof. For example, when rotationally joined, an angle of rotation a (about axis 25) to secure the sidewall 31 to the base 23 may be in a range of about 15 degrees to about 90 degrees. In one version, the sidewall 31 may be releasably coupled to the base 23. In another version, the sidewall 31 may be configured to be locked to the base 23, such that the sidewall 31 will not unintentionally unlock during normal use with plants and substrates, such as soil. Some embodiments of the sidewall 31 may be joined to the base 23 with a mechanical or heat stake, sonic weld, adhesive, fastener, or a combination thereof.

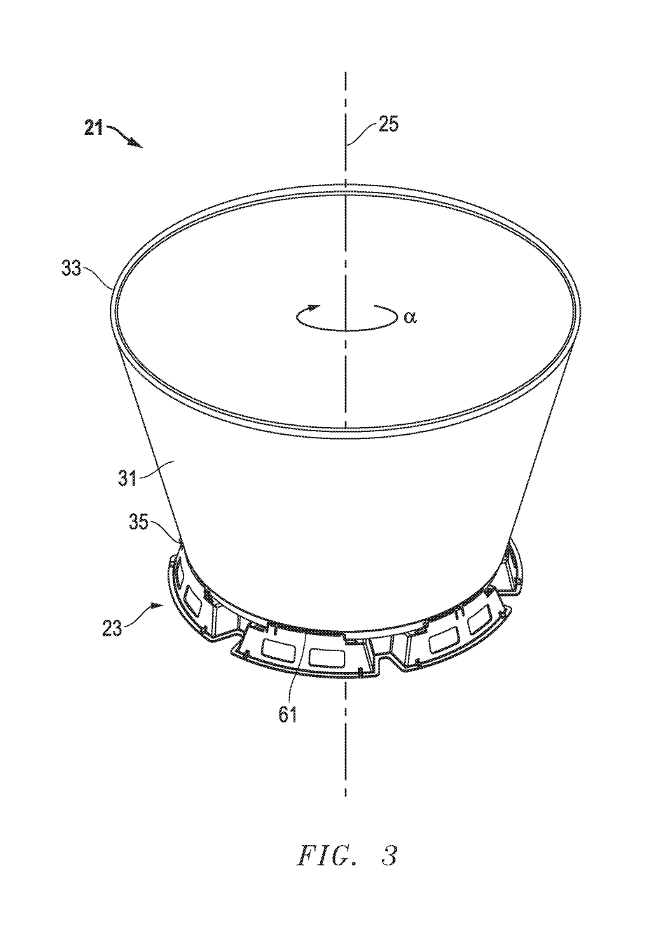

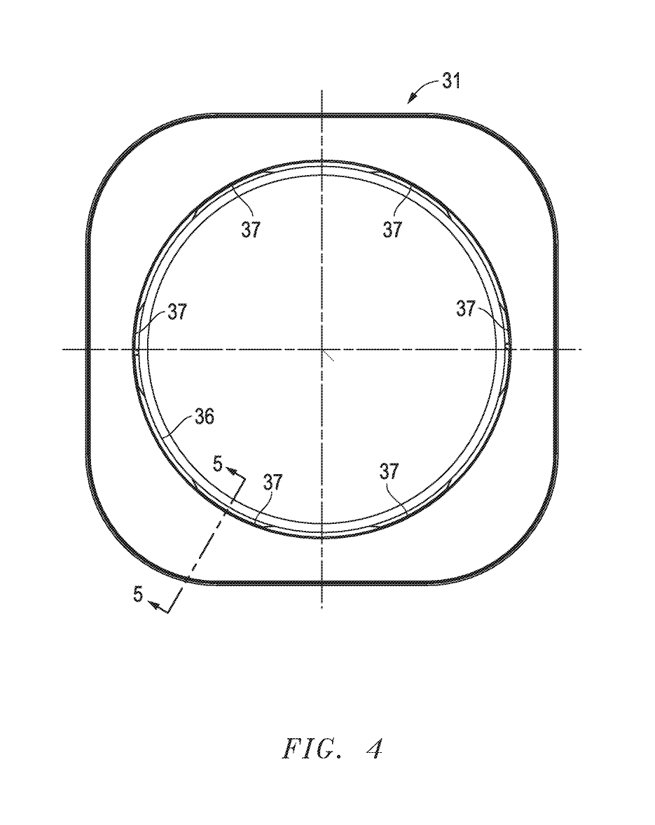

Versions of the container 21 may be configured in a variety of shapes, such as polygonal (FIGS. 1 and 2), round (FIG. 3), and still other shapes. For example, the sidewall 31 may include an upper end 33 that is square with rounded corners (FIGS. 1 and 2), and a lower end 35 that is circular. In another version, the sidewall 31 may be frustoconical (FIG. 3) in shape from the upper end 33 to the lower end 35. The base 23 can be generally circular, disk-like or still other shapes. An example of the lower end 35 may be cylindrical (FIGS. 2 and 6). In addition, a lip 36 (FIGS. 4 and 6) may extend radially inward from the lower end 35.

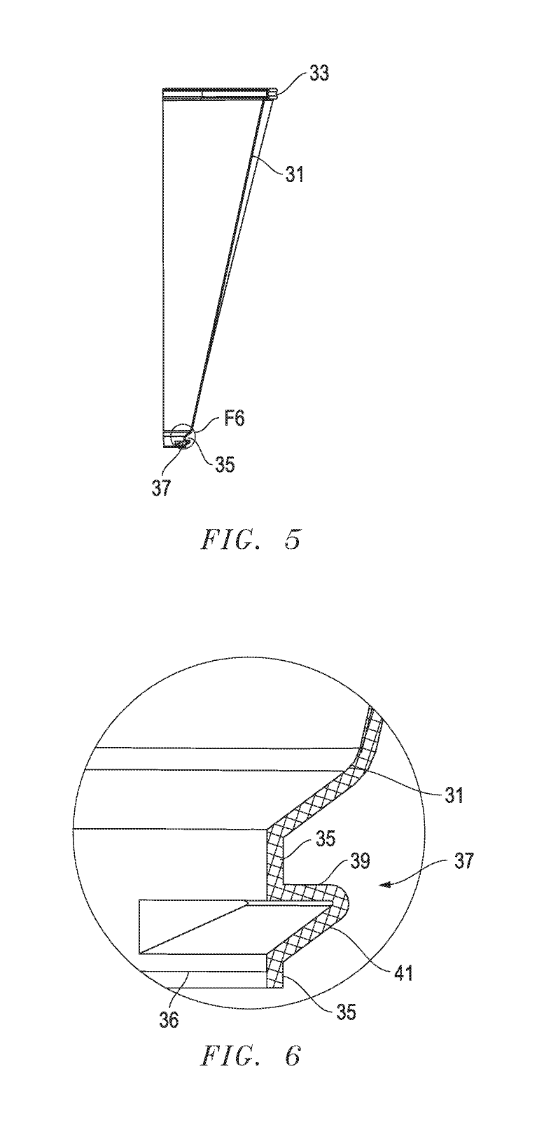

Embodiments of the sidewall 31 may include the lower end 35 and a plurality of ribs 37 (FIG. 2) on the lower end. As shown in FIG. 4, the ribs 37 may circumscribe the lower end 35. In some versions, the ribs 37 may be symmetrically spaced apart from each other about the axis 25. The ribs 37 may extend radially outward (FIGS. 5 and 6) from the sidewall 31, relative to the axis 25.

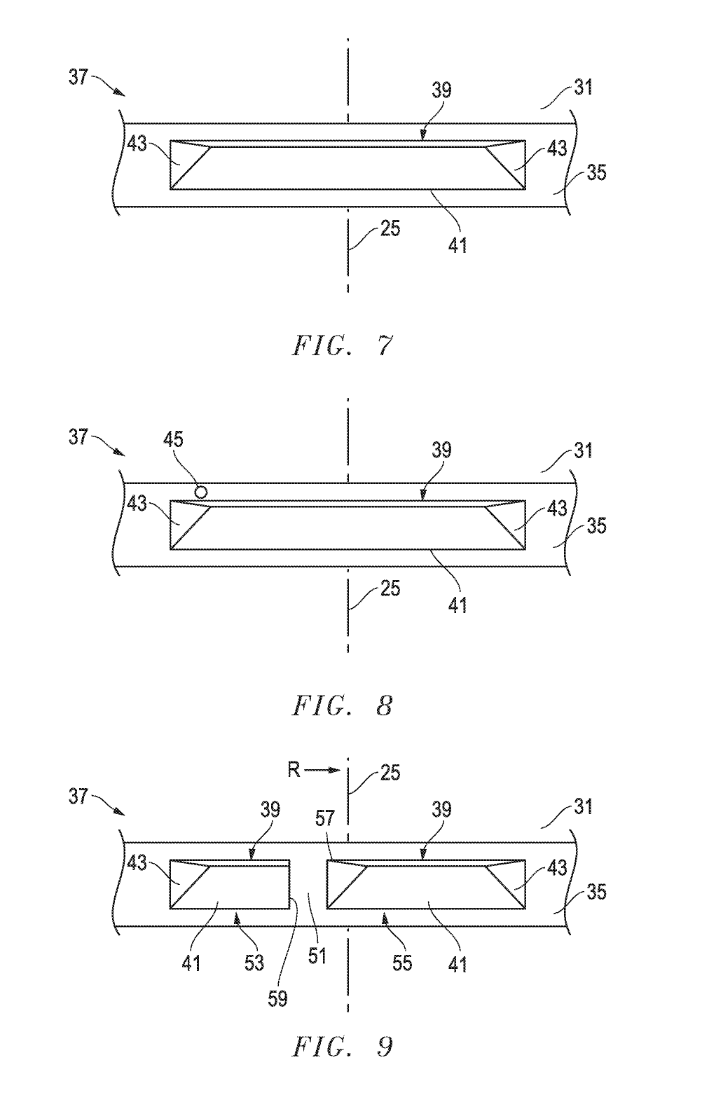

Some versions of the ribs 37 are identical to each other, and other versions are not identical to each other. For example, relative to the axis 25, the ribs 37 may include top surfaces 39 (FIGS. 6 and 7) that may be substantially horizontal. The top surfaces 39 of the ribs 37 also may be co-planar. In addition, the ribs 37 may include have bottom surfaces 41. The bottom surfaces 41 may be tapered, such as the axial taper shown. Embodiments of the ribs 37 may be circumferentially elongated (relative to axis 25) and beveled on each circumferential end 43 (FIG. 7).

In one example, the sidewall 31 may further include at least one pin hole 45 (FIG. 8) extending therethrough. For example, the pin hole 45 may be located adjacent to one of the ribs 37. A version of the pin hole 45 may be located axially above the rib 37. Moreover, the pin hole 45 may be located adjacent to one circumferential end 43 of the rib 37.

In some embodiments, at least one of the ribs 37 may be segmented by a notch 51 (FIG. 9) extending in an axial direction. For example, the segmented rib 37 may include a first segment 53 and a second segment 55. The notch 51 may be located between the first and second segments 53, 55. Versions of the first segment 53 may be circumferentially longer than the second segment 55, as shown. Embodiments of a first end 57 of the notch 51 may be circumferentially beveled. A second end 59 of the notch 51 can extend essentially in a radial direction (with respect to axis 25), and can be substantially perpendicular to the sidewall 31. In one example, the first end 57 of the notch 51 can be in a direction of rotation, R, of the sidewall 31 relative to the base 23 to permit relative rotation therebetween. Examples of the second end 59 of the notch 51 may form a mechanical stop to prevent rotation of the sidewall 31 relative to the base 23. In a version (FIG. 7), at least one of ribs 37 may not have a notch 51. Similarly, at least one of the ribs 37 may not have a pin hole 45 adjacent to it.

Embodiments of the base 23 (FIGS. 1-3) may include a perimeter having a plurality of tabs 61 adjacent thereto. The tabs 61 may be configured to engage respective ribs 37 on the sidewall 31. For example, the tabs 61 may form recesses or sockets 63 for the ribs 37. In some versions, the tabs 61 may not be identical.

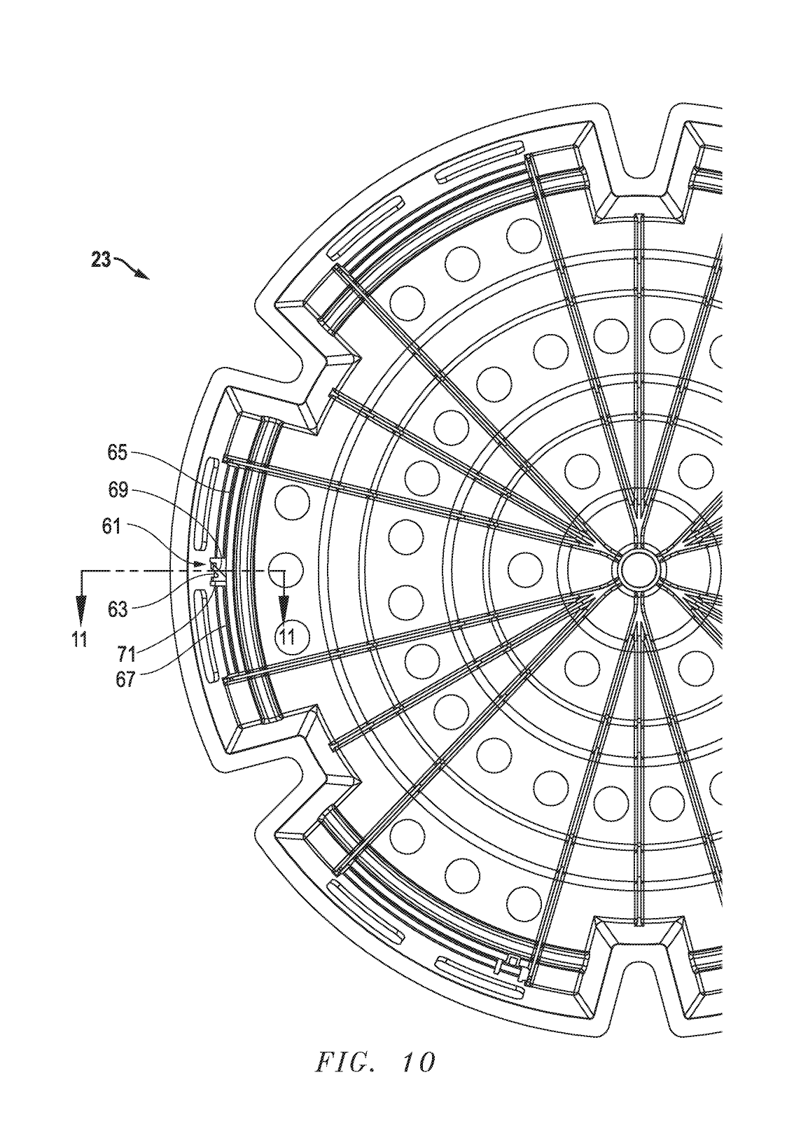

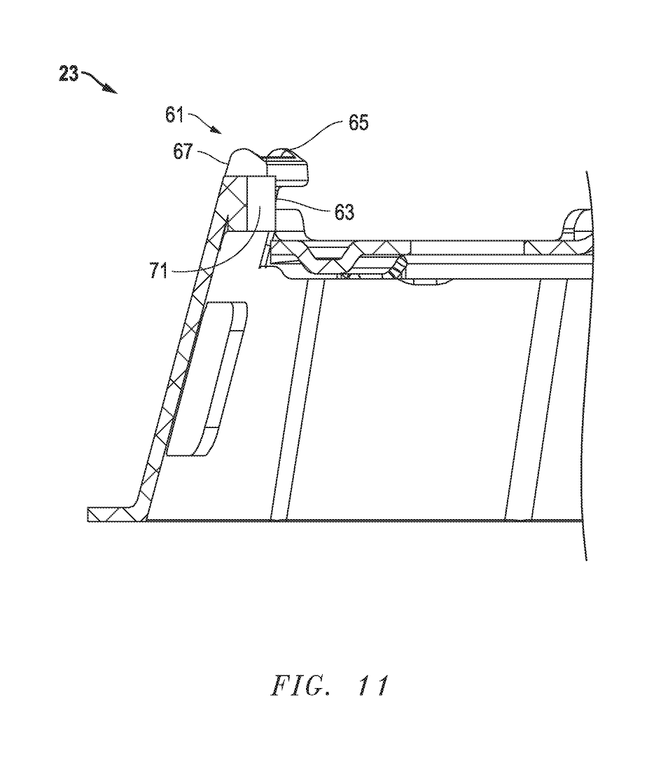

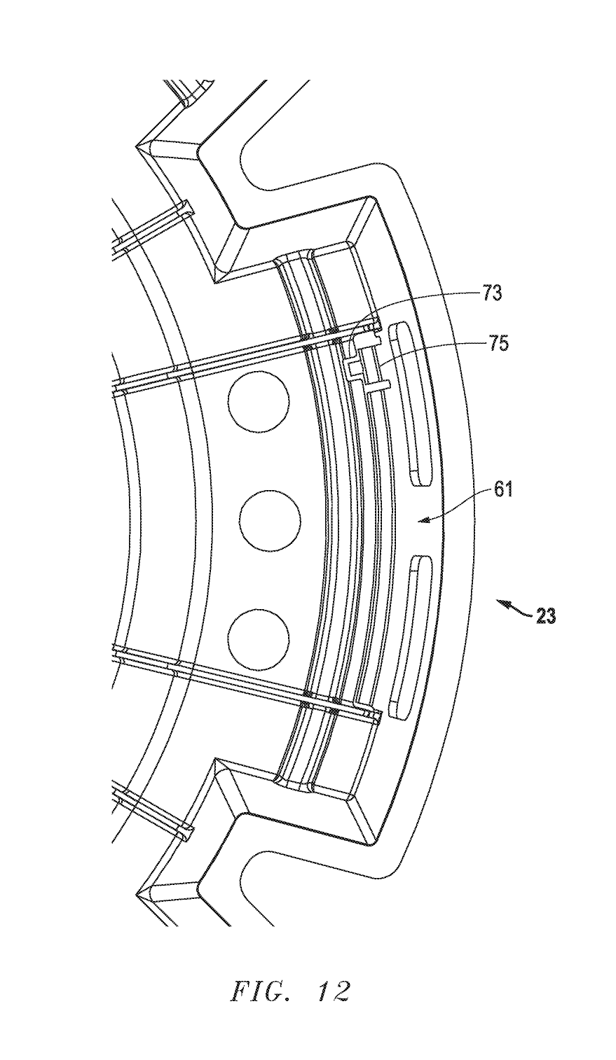

In one embodiment, at least one of the tabs 61 may include a catch 63 (FIGS. 2, 10 and 11). The catch 63 may be configured to engage the notch 51 (FIG. 9) in one of the ribs 37. For example, the catch 63 may extend axially upward from the base 23. The catch 63 may be cantilevered such that the catch 63 is configured to flex when the base 23 engages the sidewall 31. In some versions, the catch 63 may segment at least one of the tabs 61 into a first segment 65 and a second segment 67. The first and second segments 65, 67 may be approximately equal in circumferential length. An example of the catch 63 may protrude radially inward relative to the axis 25. A version of the catch 63 may include a leading circumferential side 69 that may be beveled for allowing relative rotation between the base 23 and the sidewall 31. The catch may further include a trailing circumferential side 71 that may be substantially perpendicular to the axis 25 for preventing relative rotation between the base 23 and the sidewall 61.

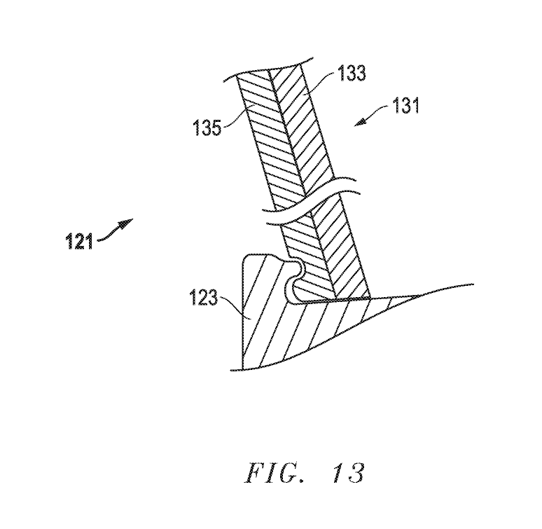

In another embodiment, at least one of the tabs 61 may include a pin 73 (FIGS. 2 and 12). The pin 73 may be configured to engage the pinhole 45 (FIG. 8) adjacent one of the ribs 37. For example, the pin 73 may extend from a peg 75. The peg 75 may be cantilevered and extend axially upward from the base 23, such that the peg 75 may be configured to flex when the base 23 engages the sidewall 31. The pin 73 may extend radially inward from the peg 75. In one version, the peg 75 may be located at a circumferential end of the tab 61. In addition, the peg 75 may segment the tab 61 into two segments. In other versions (FIG. 2), at least one of the tabs 61 may not have a catch 63 or a pin 73.

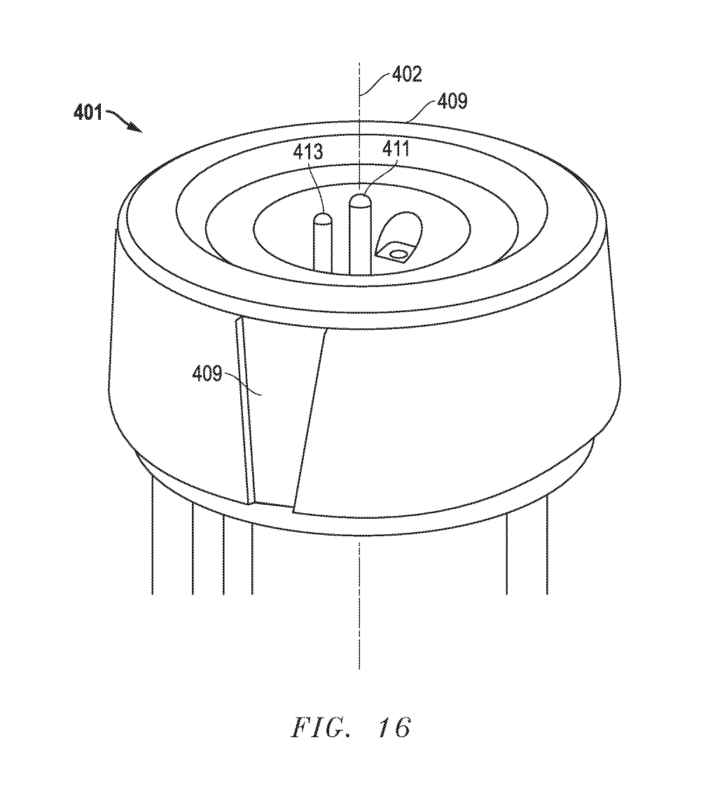

Embodiments of the tabs 61 may extend from feet 77. The feet 77 may be circumferentially arrayed in a symmetrical pattern and separated by recesses 79. The recesses 79 may be open (FIG. 2) or closed (FIG. 15) by thin layers that horizontally span between the bottoms of feet 77.

Examples of the base 23 may further include one or more tiers 81, 83, 85 of drain holes 87, which may be located concentrically within the tabs 61. The tiers 81, 83, 85 of drain holes 87 may ascend in elevation toward the axis 25. In one version, a fewest number of drain holes 87 may be located on a tier 85 adjacent the axis 25. In another version, a larger number of drain holes 87 may be located in a tier 81 adjacent the perimeter of the base 23. In one example, a largest number of drain holes 87 may be located on a tier 83 between the axial tier 85 and the perimeter tier 81. The base 23 also may further include an axial dimple 89. The axial dimple 89 may be located concentrically within the axial tier 85. The axial dimple 89 may extend axially upward. In addition, at least some of the drain holes 87 also may function as function as ventilation holes.

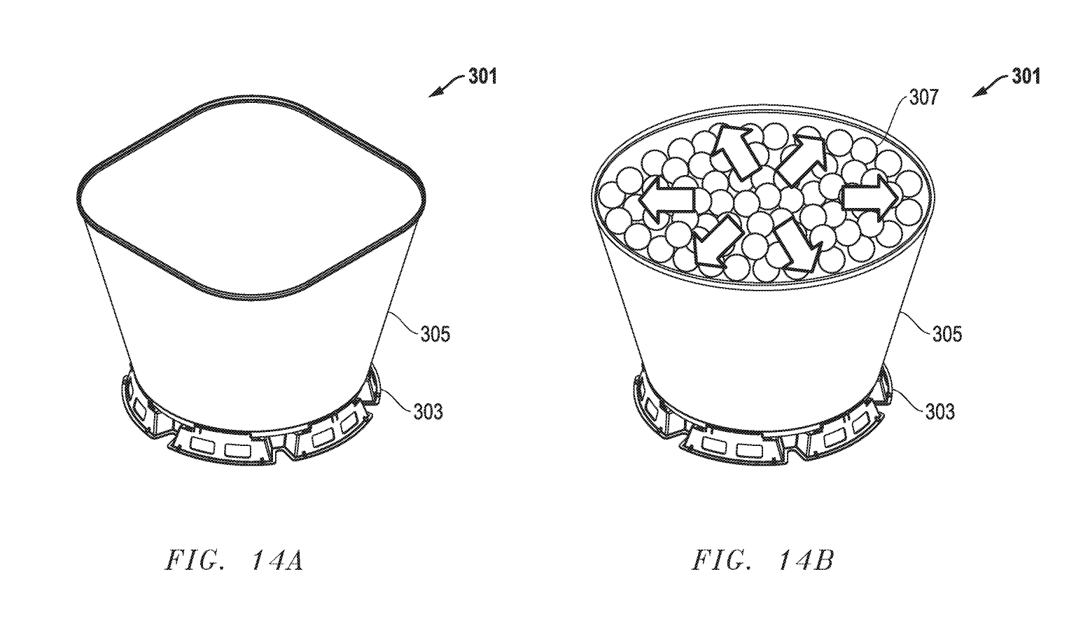

In still another embodiment (FIG. 13), a container 121 for a plant may include a base 123 and a sidewall 131 coupled to the base 123. The sidewall 131 may include an inner layer 133 and an outer layer 135. The outer layer 135 may be lighter in color than the inner layer 133. The outer layer 135 may be configured to reflect light away from the container 121. The inner layer 133 may be darker in color than the outer layer 135. The inner layer 133 may be configured to protect roots of the plant in the container 121 from light exposure.

In addition, the outer layer 135 may be thinner than the inner layer 133. For example, the outer layer 135 may have a wall thickness in a range of about 0.1 mm to about 0.25 mm. Some versions of the inner layer 133 may have a wall thickness in a range of about 0.5 mm to about 0.65 mm. The wall thickness of one or both layers 133, 135 may vary axially. For example, the wall thickness of one or both layers 133, 135 at a top portion thereof may be less than the wall thickness of one or both layers 133, 135 at a bottom portion thereof.

Other embodiments may include a total wall thickness of about 0.75 mm to about 1.3 mm. The total wall thickness may vary axially. For example, the total wall thickness of the sidewall 131 at the top thereof may be less than the total wall thickness of the sidewall 131 at a bottom thereof.

Regarding coloration, CIELAB is the second of two systems adopted by CIE in 1976 as models that better showed uniform color spacing in their values. CIELAB is an opponent color system based on the earlier (1942) system of Richard Hunter called L, a, b. Color opposition correlates with discoveries in the mid-1960s that somewhere between the optical nerve and the brain, retinal color stimuli are translated into distinctions between light and dark, red and green, and blue and yellow. CIELAB indicates these values with three axes: L*, a*, and b*. The full nomenclature is 1976 CIE L*a*b* Space. A central vertical axis represents lightness (signified as L*) whose values run from 0 (black) to 100 (white). The color axes are based on the fact that a color cannot be both red and green, or both blue and yellow, because these colors oppose each other. On each axis the values run from positive to negative. On the a-a′ axis, positive values indicate amounts of red while negative values indicate amounts of green. On the b-b′ axis, yellow is positive and blue is negative. For both axes, zero is neutral gray.

Accordingly, color may be claimed as a CIE color unit L* value having a range from zero (0) or black, up to 100 or pure white. Embodiments of the inner layer 133 may have a CIE color unit L*<70. In other embodiments, the inner layer 133 may have a CIE color unit L*<60, a CIE color unit L*<50, a CIE color unit L*<40, a CIE color unit L*<30, a CIE color unit L*<20, a CIE color unit L*<10, or even a CIE color unit L*<5. The CIE color unit L* of the inner layer 133 also may be in a range between any of these values.

Similarly, embodiments of the outer layer 135 may have a CIE color unit L*>30. In other embodiments, the outer layer 135 may have a CIE color unit L*>40, a CIE color unit L*>50, a CIE color unit L*>60, a CIE color unit L*>70, a CIE color unit L*>80, a CIE color unit L*>90, or even a CIE color unit L*>95. The CIE color unit L* of the outer layer 135 also may be in a range between any of these values.

In some embodiments, the inner and outer layers 133, 135 may differ from each other in color by at least about 50 L* CIE color units, such as at least about 60 L* CIE color units, at least about 70 L* CIE color units, at least about 80 L* CIE color units, at least about 90 L* CIE color units, or even at least about 95 L* CIE color units. In other examples, the inner and outer layers 133, 135 may differ from each other in color by not greater than about 95 L* CIE color units, such as not greater than about 85 L* CIE color units, not greater than about 75 L* CIE color units, not greater than about 65 L* CIE color units, not greater than about 55 L* CIE color units, not greater than about 45 L* CIE color units, or even not greater than about 35 L* CIE color units. The color differential also may be within a range defined by any of these minimum and maximum values.

In other examples, the outer layer 135 can be substantially white, and/or the inner layer 133 can be substantially black. The base 123 can be black. In another version, the base 123, inner layer 133 and the outer layer 135 may comprise polyethylene or polypropylene. Optionally, the outer layer 135 may be a form of a shade of terra cotta, or a shade of green. In another example, the outer layer 135 can be thinner than the inner layer 133. The outer layer 135 may be at least somewhat translucent such that it is not completely opaque.

There are other embodiments of a method of forming a container 21 (FIGS. 1 and 2) for a plant. For example, versions of the method may include providing a base 23 with an axis 25 and a sidewall 31; axially placing the sidewall 31 onto the base 23; and then rotating the base 23 and the sidewall 31 relative to each other about the axis 25 to form the container 21. This method may include applying a slight axial force between the base 23 and sidewall 31. The method also may include locking the base 23 and sidewall 31 to each other.

Another embodiment of a container 21 for a plant is again depicted in FIGS. 1-3. The container 21 may include a base 23 and a first sidewall 31 (FIGS. 1 and 2) having a first shape (e.g., a generally square top with rounded corners, as shown). The first sidewall 31 may be configured to be interchangeably mountable to the base 23. In addition, a second sidewall 31 (FIG. 3) may have a second shape (e.g., generally conical) that is different from the first shape. The second sidewall 31 may be configured to be interchangeably mountable to the base 23 when the first sidewall 31 is not mounted to the base 23.

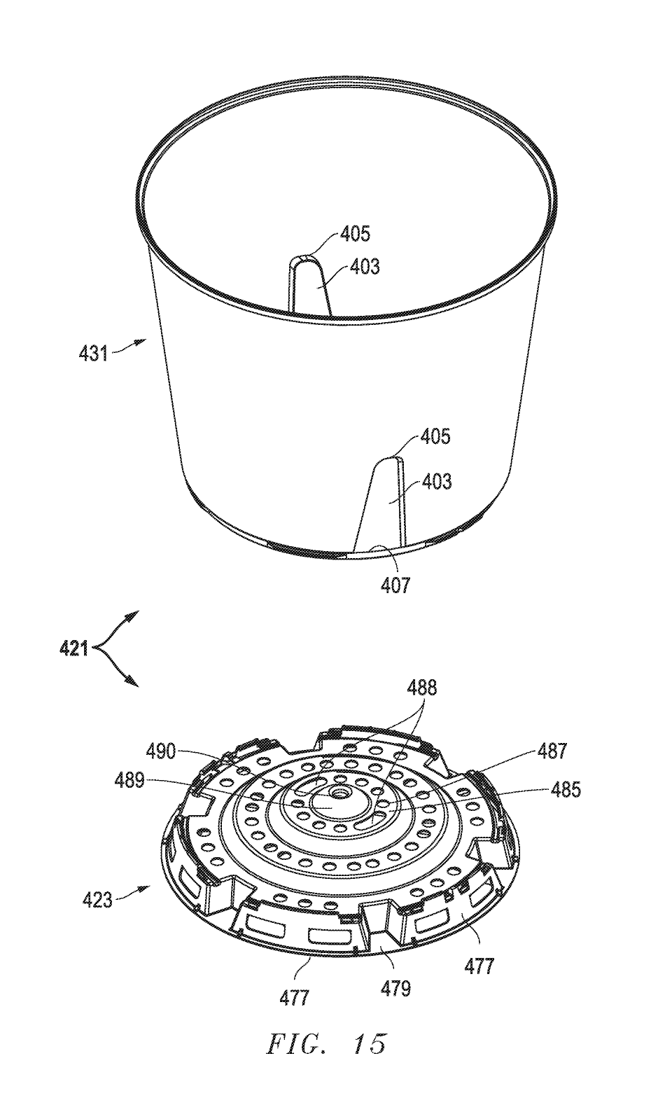

Referring now to FIGS. 14A and 14B, an embodiment of a container 301 for a plant may include a base 303 and a sidewall 305 attached to the base 303. When the container 301 is not substantially filled with a plant substrate (e.g., at least mostly empty, as shown in FIG. 14A), the sidewall 305 has a nominal sidewall shape. For example, the nominal shape may be polygonal, such as a generally square top with rounded corners. However, when the container 301 begins to fill or is substantially filled with a plant substrate 307 (FIG. 14B), the sidewall 305 may be forced outward by the plant substrate 307 to shift the sidewall 305 to a second sidewall shape. For example, the second sidewall shape could be non-polygonal, such as a generally round shape, that differs from the nominal sidewall shape.

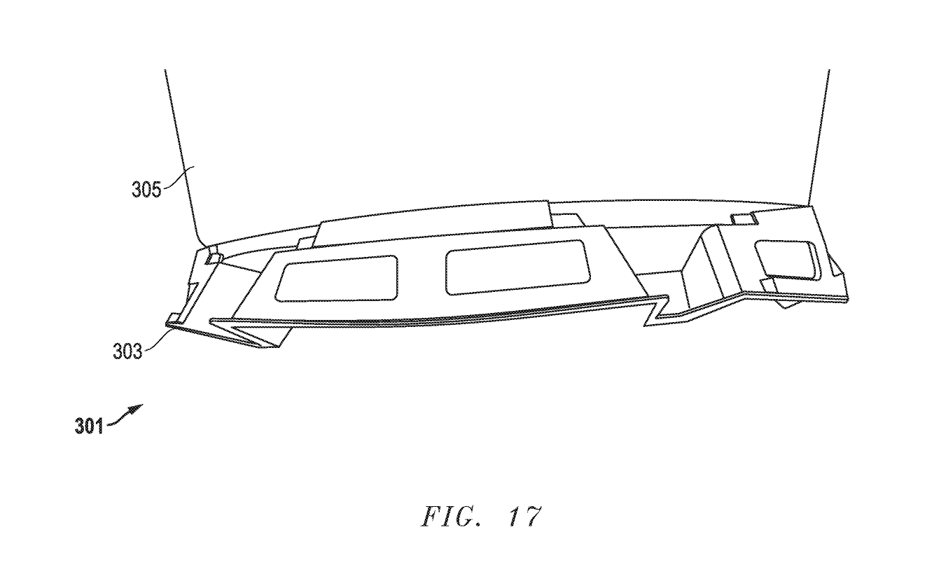

FIG. 17 depicts another embodiment of a container 301. Adding substrate to the container 301 adds weight. In some versions, the weight of the substrate causes the base 303 to intentionally deform and grip the sidewall 303 at a higher force of retention. In some versions, the weight of the substrate can cause the bottom of the base 303 to intentionally deform and flare outward and upward, as shown.

In some versions, the sidewall 305 may have sufficient sidewall thickness and turgidity to remain upright and not sag when attached to the base 303. However, in other embodiments, the sidewall may be somewhat thin and flexible (e.g., bag-like) and lack rigidity, such that some sag is permitted. In some versions, the shape shift of the sidewall 305 from the nominal sidewall shape to the second sidewall shape can be in a prescribed range, such as from about 10% to about 90% of a change in shape. Embodiments of the sidewall 305 may be sufficiently strong and attached to the base 303 such that lifting the container 301 by only the sidewall 305 also lifts the base 303. The base 303 and sidewall 305 may be attached by any known means, such as those disclosed elsewhere herein.

FIG. 15 depicts another embodiment of a container 421 for a plant. In this version, the base 423 and sidewall 431 may be configured as described for the other embodiments disclosed herein. In addition, container 421 may be configured to be assembled by a fixture 401 (FIG. 16). For example, the sidewall 431 may be provided with protrusions 403. Embodiments of the protrusions 403 may extend radially inward, such that recesses appear on the exterior of sidewall 431. Versions of the protrusions 403 may include a substantially flat, tapered, substantially vertical orientation, as shown, that is substantially parallel to the sidewall 431, and offset from each other by 180 degrees. In some examples, the narrowest portions of the protrusions may be their tops 405, which may be rounded, and widest portions of the protrusions may be at their bottoms 407.

Embodiments of base 423 may include a tier 485 of holes 487 with at least one kidney-shaped hole 488 (e.g., two shown). Base 423 may further comprise an axial dimple 489 having a beveled aperture 490 in its center.

Embodiments of a method of assembling the container 421 for a plant may include a base 423, a sidewall 431 configured to be coupled to the base, and the fixture 401 (FIG. 16) to couple the sidewall 431 to the base 423. For example, in operation, fixture 401 may be positioned in front of a user with axis 402 in a substantially vertical orientation. A sidewall 431 is inverted upside down (i.e., rotated 180 degrees from FIG. 15), substantially axially aligned with the fixture 401, and placed on the fixture 401. Fixture 401 may be conical in shape and provided with recesses 409 on its outer surface. Recesses 409 are complementary in shape to and closely receive protrusions 403 on sidewall 431. If protrusions 403 are rotationally misaligned with recesses 409, sidewall 431 may be rotated until the protrusions 403 seat in the recesses 409 to prevent sidewall 431 from further rotation.

Next, a base 423 is inverted upside down (i.e., rotated 180 degrees from FIG. 15), substantially axially aligned with the fixture 401, and placed on the sidewall 431 that is on fixture 401. Embodiments of the top of the fixture 401 may be recessed in such a manner as to be complementary in shape to and receive the top of base 423. In some versions, fixture 401 has an axial pin 411 that extends through the beveled aperture 490, and an eccentric pin 413 that extends through one of the two kidney-shaped holes 488. In other versions, fixture 401 may have an eccentric pin 413 for each kidney-shaped hole 488. The pins 411, 413 may be sized differently to aid in assembly.

With base 423 properly installed, features on base 423 are ready to be engaged with features on sidewall 431. Base 423 is then rotated until the respective features engage to form the assembled container 421. The assembled container 421 is removed from the fixture 401, and the process may be repeated to form other assembled containers 421.

Other versions may include one or more of the following embodiments:

Embodiment 1. A container for a plant, comprising:

a base having an axis; and

a sidewall configured to be rotationally attached to the base about the axis to form the container, and the sidewall is configured to surround a portion of the base and extend axially upward from the base.

Embodiment 2. The container of any of these embodiments, wherein an angle of rotation to secure the sidewall to the base is in a range of about 15 degrees to about 90 degrees.

Embodiment 3. The container of any of these embodiments, wherein the sidewall is configured to be locked to the base.

Embodiment 4. The container of any of these embodiments, wherein the sidewall is secured to the base with at least one of a stake, sonic weld, adhesive and fastener.

Embodiment 5. The container of any of these embodiments, wherein the sidewall is releasably coupled to the base.

Embodiment 6. The container of any of these embodiments, wherein both the base and the sidewall are substantially conical in shape.

Embodiment 7. The container of any of these embodiments, wherein the sidewall comprises an upper end that is square with rounded corners, the sidewall has a lower end that is circular, and the base is circular.

Embodiment 8. The container of any of these embodiments, wherein the base comprises a different material than the sidewall.

Embodiment 9. The container of any of these embodiments, wherein the base has a thickness that is greater than that of the sidewall.

Embodiment 10. The container of any of these embodiments, wherein the sidewall has a lower end that is cylindrical, and a lip extends radially inward from the lower end.

Embodiment 11. The container of any of these embodiments, wherein the sidewall comprises a lower end and a plurality of ribs or threads on the lower end.

Embodiment 12. The container of any of these embodiments, wherein the ribs are symmetrically spaced apart from each other about the axis, and the ribs extend radially outward from the sidewall.

Embodiment 13. The container of any of these embodiments, wherein the ribs are not identical to each other.

Embodiment 14. The container of any of these embodiments, wherein the ribs are circumferentially elongated and beveled on each circumferential end.

Embodiment 15. The container of any of these embodiments, wherein, relative to the axis, the ribs have substantially horizontal top surfaces that are substantially co-planar, and the ribs have tapered bottom surfaces.

Embodiment 16. The container of any of these embodiments, wherein the sidewall further comprises at least one pin hole extending therethrough, and the pin hole is adjacent to one of the ribs.

Embodiment 17. The container of any of these embodiments, wherein the pin hole is located axially above said one of the ribs, and the pin hole is adjacent to one circumferential end of said one of the ribs.

Embodiment 18. The container of any of these embodiments, wherein at least one of the ribs is segmented by a notch extending in an axial direction.

Embodiment 19. The container of any of these embodiments, wherein the segmented rib has a first segment and a second segment, the notch is between the first and second segments, and the first segment is circumferentially longer than the second segment.

Embodiment 20. The container of any of these embodiments, wherein a first end of the notch is circumferentially beveled, and a second end of the notch is substantially perpendicular to the sidewall.

Embodiment 21. The container of any of these embodiments, wherein the first end of the notch is in a direction of rotation of the sidewall relative to the base and permits relative rotation therebetween, and the second end of the notch forms a mechanical stop to prevent rotation of the sidewall relative to the base.

Embodiment 22. The container of any of these embodiments, wherein at least one of ribs does not have a notch, and said at least one of the ribs does not have a pin hole adjacent to it.

Embodiment 23. The container of any of these embodiments, wherein the base comprises a perimeter having a plurality of tabs adjacent thereto, and the tabs are configured to engage respective ribs on the sidewall.

Embodiment 24. The container of any of these embodiments, wherein the tabs form sockets for the ribs on the sidewall.

Embodiment 25. The container of any of these embodiments, wherein the tabs are not identical.

Embodiment 26. The container of any of these embodiments, wherein at least one of the tabs comprises a catch configured to engage a notch in one of the ribs.

Embodiment 27. The container of any of these embodiments, wherein the catch extends axially upward from the base and is cantilevered such that the catch is configured to flex when the base engages the sidewall.

Embodiment 28. The container of any of these embodiments, wherein the catch segments at least one of the tabs into at least two segments.

Embodiment 29. The container of any of these embodiments, wherein the catch protrudes radially inward relative to the axis, the catch has a leading circumferential side that is beveled for allowing relative rotation between the base and the sidewall, and the catch has a trailing circumferential side that is substantially perpendicular to the axis for preventing relative rotation between the base and the sidewall.

Embodiment 30. The container of any of these embodiments, wherein at least one of the tabs comprises a pin configured to engage a pinhole adjacent one of the ribs.

Embodiment 31. The container of any of these embodiments, wherein the pin extends from a peg that is cantilevered and extends axially upward from the base, such that the peg is configured to flex when the base engages the sidewall, and the pin extends radially inward from the peg.

Embodiment 32. The container of any of these embodiments, wherein the peg is located at a circumferential end of said at least one of the tabs.

Embodiment 33. The container of any of these embodiments, wherein the peg segments said at least one of the tabs into at least two segments.

Embodiment 34. The container of any of these embodiments, wherein at least one of the tabs does not have a catch or a pin.

Embodiment 35. The container of any of these embodiments, wherein the tabs extend from feet that are circumferentially arrayed in a symmetrical pattern and separated by recesses.

Embodiment 36. The container of any of these embodiments, wherein the base comprises a plurality of tiers of drain holes located concentrically within the tabs.

Embodiment 37. The container of any of these embodiments, wherein the tiers of drain holes ascend in elevation toward the axis, a fewest number of drain holes is located on a tier adjacent the axis, a larger number of drain holes is located in a tier adjacent the perimeter, and a largest number of drain holes is located on a tier between the axial tier and the perimeter tier.

Embodiment 38. The container of any of these embodiments, further comprising an axial dimple located concentrically within the axial tier, and the axial dimple extends axially upward.

Embodiment 39. A container for a plant, comprising:

a base; and

a sidewall configured to be mounted to the base, the sidewall having an inner layer and an outer layer, the outer layer is lighter in color than the inner layer, the outer layer is configured to reflect light away from the container, the inner layer is darker in color than the outer layer, and the inner layer is configured to protect roots of the plant in the container from light exposure.

Embodiment 40. The container of any of these embodiments, wherein the outer layer has a CIE color unit L*>70, and the inner layer has a CIE color unit L*<30.

Embodiment 41. The container of any of these embodiments, wherein the outer layer is substantially white, and the inner layer is substantially black.

Embodiment 42. The container of any of these embodiments, wherein the base, inner layer and outer layer comprise polyethylene or polypropylene, and the base is black.

Embodiment 43. The container of any of these embodiments, wherein the outer layer is a shade of terra cotta, or a shade of green.

Embodiment 44. The container of any of these embodiments, wherein the outer layer has a thinner wall thickness than the inner layer, and the outer layer wall thickness is not greater than about 0.3 mm.

Embodiment 45. The container of any of these embodiments, wherein the outer layer is at least somewhat translucent such that it is not completely opaque.

Embodiment 46. The container of any of these embodiments, wherein the outer layer has a wall thickness that is less than that of the inner layer.

Embodiment 47. The container of any of these embodiments, wherein the outer layer has a wall thickness in a range of about 0.1 mm to about 0.25 mm.

Embodiment 48. The container of any of these embodiments, wherein the inner layer has a wall thickness in a range of about 0.5 mm to about 0.65 mm.

Embodiment 49. The container of any of these embodiments, wherein a wall thickness of at least one of the outer and inner layers varies axially.

Embodiment 50. The container of any of these embodiments, wherein a wall thickness of at least one of the outer and inner layers at a top portion thereof is less than the wall thickness of said at least one of the outer and inner layers at a bottom portion thereof.

Embodiment 51. The container of any of these embodiments, wherein the sidewall comprises a total wall thickness of about 0.75 mm to about 1.3 mm.

Embodiment 52. The container of any of these embodiments, wherein the sidewall has a total wall thickness that varies axially.

Embodiment 53. The container of any of these embodiments, wherein the total wall thickness of the sidewall at a top portion thereof is less than the total wall thickness of the sidewall at a bottom portion thereof.

Embodiment 54. A method of forming a container for a plant, comprising:

(a) providing a base with an axis and a sidewall that is a separate component from the base;

(b) axially placing the sidewall onto the base; and then

(c) rotating the base and the sidewall relative to each other about the axis to form the container.

Embodiment 55. The method of any of these embodiments, wherein step (b) comprises applying a slight axial force between the base and sidewall.

Embodiment 56. The method of any of these embodiments, wherein step (c) comprises locking the base and sidewall to each other.

Embodiment 57. The method of any of these embodiments, wherein steps (b) and (c) comprise using a fixture to form the container.

Embodiment 58. The method of any of these embodiments, further comprising, after step (c), adding substrate to the container, such that a weight of the substrate causes the base to deform and grip the sidewall at a higher force of retention.

Embodiment 59. A container for a plant, comprising:

a base having an axis;

a sidewall configured to be coupled to the base, wherein the sidewall is tubular; and

a fixture configured to couple the sidewall to the base by rotating the base and sidewall relative to each other.

Embodiment 60. The container of any of these embodiments, wherein a top of the fixture is complementary in shape to a top of the base, and a side of the fixture is complementary in shape to an interior of the sidewall.

Embodiment 61. The container of any of these embodiments, wherein the fixture comprises exterior recesses that are complementary in shape to interior protrusions of the sidewall to prevent relative rotation therebetween.

Embodiment 62. The container of any of these embodiments, wherein the fixture comprises pins that are configured to engage apertures in the base.

Embodiment 63. The container of any of these embodiments, wherein the pins comprise an axial pin and an eccentric pin that is eccentric to the axis.

Embodiment 64. The container of any of these embodiments, wherein the pins comprise different sizes.

Embodiment 65. A container for a plant, comprising:

a base;

a first sidewall having a first shape, and the first sidewall is configured to be interchangeably mountable to the base; and

a second sidewall having a second shape that is different from the first shape, and the second sidewall is configured to be interchangeably mountable to the base when the first sidewall is not mounted to the base.

Embodiment 66. A container for a plant, comprising:

a base; and

a sidewall attached to the base, wherein when the container is not substantially filled with a plant substrate, the sidewall has a nominal sidewall shape, and when the container is substantially filled with the plant substrate, the sidewall is forced by the plant substrate to shift to a second sidewall shape that differs from the nominal sidewall shape.

Embodiment 67. The container of any of these embodiments, wherein, when the container does not contain substrate, the sidewall has sufficient sidewall thickness and turgidity to remain upright and not sag when attached to the base.

Embodiment 68. The container of any of these embodiments, wherein the nominal sidewall shape is polygonal, and the second sidewall shape is not polygonal.

Embodiment 69. The container of any of these embodiments, wherein the nominal sidewall shape is substantially rectangular, and the second sidewall shape is substantially conical.

Embodiment 70. The container of any of these embodiments, wherein the shape shift from the nominal sidewall shape to the second sidewall shape is in a range from about 10% to about 90%.

Embodiment 71. The container of any of these embodiments, wherein the sidewall is sufficiently attached to the base such that lifting the container by only the sidewall also lifts the base.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A container for a plant, comprising:
a base having an axis; and
a sidewall configured to be rotationally attached to the base about the axis to form the container, and the sidewall is configured to surround a portion of the base and extend axially upward from the base.

2. The container of claim 1, wherein an angle of rotation to secure the sidewall to the base is in a range of about 15 degrees to about 90 degrees.

3. The container of claim 1, wherein the sidewall is configured to be locked to the base.

4. The container of claim 1, wherein the sidewall is secured to the base with at least one of a stake, sonic weld, adhesive and fastener.

5. The container of claim 1, wherein the sidewall is releasably coupled to the base, and the base comprises a different material than the sidewall.

6. The container of claim 1, wherein the base comprises a perimeter having a plurality of tabs adjacent thereto, and the tabs are configured to engage respective ribs on the sidewall.

7. A container for a plant, comprising:
a base; and
a sidewall configured to be mounted to the base, the sidewall having an inner layer and an outer layer, the outer layer is lighter in color than the inner layer, the outer layer is configured to reflect light away from the container, the inner layer is darker in color than the outer layer, and the inner layer is configured to protect roots of the plant in the container from light exposure.

8. The container of claim 7, wherein the outer layer has a CIE color unit L*>70, and the inner layer has a CIE color unit L*<30.

9. The container of claim 7, wherein the outer layer is one of: substantially white, a shade of terra cotta, and a shade of green; and the inner layer is substantially black.

10. The container of claim 7, wherein the outer layer has a thinner wall thickness than the inner layer, and the outer layer wall thickness is not greater than about 0.3 mm.

11. The container of claim 7, wherein the outer layer is at least somewhat translucent such that it is not completely opaque; and the outer layer has a wall thickness that is less than that of the inner layer.

12. The container of claim 7, wherein the outer layer has a wall thickness in a range of about 0.1 mm to about 0.25 mm; and the inner layer has a wall thickness in a range of about 0.5 mm to about 0.65 mm.

13. The container of claim 7, wherein a wall thickness of at least one of the outer and inner layers varies axially.

14. The container of claim 7, wherein a wall thickness of at least one of the outer and inner layers at a top portion thereof is less than the wall thickness of said at least one of the outer and inner layers at a bottom portion thereof.

15. The container of claim 7, wherein the sidewall comprises a total wall thickness of about 0.75 mm to about 1.3 mm.

16. The container of claim 7, wherein the sidewall has a total wall thickness that varies axially.

17. A method of forming a container for a plant, comprising:
(a) providing a base with an axis and a sidewall that is a separate component from the base;
(b) axially placing the sidewall onto the base; and then
(c) rotating the base and the sidewall relative to each other about the axis to form the container.

18. The method of claim 17, wherein step (b) comprises applying a slight axial force between the base and sidewall; and step (c) comprises locking the base and sidewall to each other.

19. The method of claim 17, wherein steps (b) and (c) comprise using a fixture to form the container.

20. The method of claim 17, further comprising, after step (c), adding substrate to the container, such that a weight of the substrate causes the base to deform and grip the sidewall at a higher force of retention.
